(19) United States
(12) Patent Application Publication
(10) Pub. No.: US 2005/0207636 A1
(43) Pub. Date: Sep. 22, 2005

(54) AUTOMATIC-PACKAGING APPARATUS WHICH CAN PACKAGE AN OPTICAL SENSING MODULE WITH A PREFERRED DISTANCE BETWEEN A LENS AND AN OPTICAL SENSOR

(76) Inventors: Chia-Yi Liu, Hsin-Chu City (TW); Wen-Hsin Chuang, Hsin-Chu City (TW); Jin-Hsin Yang, Hsin-Chu City (TW); Chuan-Hsin Lee, Hsin-Chu City (TW); Tzu-Yi Chao, Hsin-Chu City (TW)

Correspondence Address: NORTH AMERICA INTERNATIONAL PATENT OFFICE (NAIPC), P.O. BOX 506, MERRIFIELD, VA, 22116, US

(21) Appl. No.: 10/710,890

(22) Filed: Aug. 11, 2004

(30) Foreign Application Priority Data
Mar. 18, 2004 (TW) 093107276

(51) Int. Cl. G06K 9/00

(52) U.S. Cl. 382/141

(57) ABSTRACT

An automatic-packaging apparatus which can package an optical sensing module with a preferred distance between a lens and an optical sensor includes a base, an image-analyzing module, a distance-adjusting module, and a stain-detecting module. The automatic-packaging apparatus packages a lens and an optical sensor separated in a preferred distance into an optical sensing module, and is able to detect if there are stains on the lens or there are flaws in the optical sensor. The advantages of the automatic-packaging apparatus are to package and detect optical modules quickly, efficiently and accurately.

### BACKGROUND OF INVENTION

1. Field of the Invention

The present invention relates to an automatic-packaging apparatus, and more particularly, to an automatic-packaging apparatus which can package an optical sensing module with a preferred distance between a lens and an optical sensor.

2. Description of the Prior Art

Optical devices are applied in many fields, including optical communications, displays, digital cameras, and so forth. However, optical sensors are indispensable optical modules in the above applications. Therefore, optical sensors have become a major optic-electronics product.

There are two kinds of optical sensors, the charge coupled device (CCD) and the CMOS sensor. The CCD often used in a digital camera is a kind of semiconductor which is sensitive to a change of light. The CCD can transform an optical image signal into the form of charges stored on the surface of the CCD. Thus, the light intensity is easily detected according to the amount of the stored charges. The CMOS sensor is made of Si and Ge. By the effect of both N-type and P-type semiconductors existing in the CMOS sensor, the current is generated to reflect the image signals.

However, when an optical module is produced by the factory, it includes an optical sensor and lens. Please refer to FIG. 1. FIG. 1 illustrates an optical sensing module 10. The optical sensing module 10 comprises lens 14, an optical sensor 16 and an interface circuit 18. The scope of an image to be detected is larger than the optical sensor, so the lens focuses the image onto the optical sensor. For the example in FIG. 1, the light source 12 forms its image on the optical sensor 16 through the lens 14. The optical signal received by the optical sensor 16 is stored in the interface circuit 18 as an electronic signal. Then, the interface circuit 18 transmits the electronic signal to other system for further image processing.

Those skilled in the art know that if an image is to be focused on the optical sensor 16 by the lens 14, there is a preferred distance (such as D shown in FIG. 1) between the lens 14 and the optical sensor 16. In the process of making the optical sensing module 10, the lens 14 and the optical sensor 16 are fixed in this preferred distance and make a package. Therefore, a user can directly use the optical sensing module 10 without aligning the lens.

In the prior art, the procedure of adjusting the distance between the lens 14 and the optical sensor 16 is as follows: firstly, a light source 12 is put outside the optical sensing module 10. Then, the image of the light source 12 is formed on the optical sensor 16 through the lens 14. There is a distance between the lens 14 and the optical sensor 16 (usually the distance is not the preferred distance). The optical sensor 16 will pass the image signal to the interface circuit 18 and the image signal is output to a computer by the interface circuit 18. Finally, the image is shown on the monitor of the computer. A tester adjusts the distance between the lens 14 and the optical sensor 16 according to the clearness of the image shown on the monitor. The preferred distance is determined by the tester to be the distance in which the image on the monitor is clearest. According to the preferred distance, the lens 14 and the optical sensor 16 are packaged to an optical sensing module 10.

The prior art method for packaging an optical sensing module has the following disadvantages: 1. Determining clearness of an image by naked eyes is not definite and consistent in each focusing. 2. Artificial focusing is not economic and efficient. 3. If there are stains on lens or some broken points on an optical sensor, it is hard for humans to detect them. Therefore, it needs an automatic-packaging apparatus to improve speed and accuracy of producing the optical sensing module.

### SUMMARY OF INVENTION

According to the claimed invention, an automatic-packaging apparatus which can package an optical sensing module with a preferred distance between a lens and an optical sensor comprises a base used for being put a lens and an optical sensor, the base further comprising an adjustment device for adjusting the distance between the lens and the optical sensor; an image-analyzing module used for analyzing an image signal received from the optical sensor and outputting an analyzed result; a distance-adjusting module, connected to the base and the image-analyzing module, for controlling the adjustment device to adjust the distance between the lens and the optical sensor according to the analyzed result; and a packaging module for packaging the lens and the optical sensor into an optical sensing module.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 illustrates an optical sensing module.

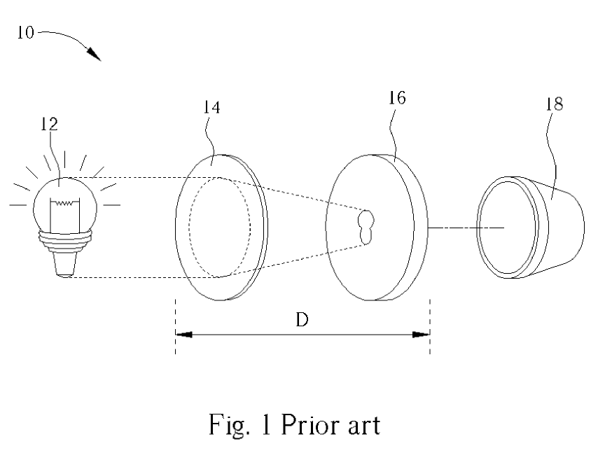

FIG. 2 illustrates an embodiment of an automatic-packaging apparatus according to the present invention.

FIG. 3 illustrates the FD (The focus-value measure based on Difference) under different distances between the lens and the optical sensor.

FIG. 4 illustrates another embodiment of the automatic-packaging apparatus according to the present invention.

FIG. 5 illustrates the structure of the base according to the present invention.

FIG. 6 illustrates a flowchart of detecting if a lens or an optical sensor has defects according to the present invention.

FIG. 7 illustrates the flowchart of deciding the preferred distance between a lens and an optical sensor in an optical sensing module according to the present invention.

### DETAILED DESCRIPTION

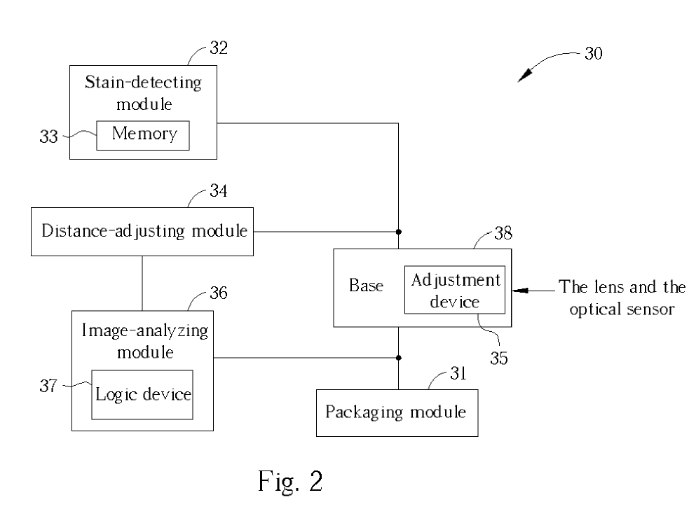

Please refer to FIG. 2. FIG. 2 illustrates an embodiment of an automatic-packaging apparatus 30 according to the present invention. The automatic-packaging apparatus 30 comprises a stain-detecting module 32, a distance-adjusting module 34, an image-analyzing module 36, a packaging module 31 and a base 38. The base 38 is used for supporting a lens and an optical sensor, between which there is a distance. The base 38 further comprises an adjustment device 35 to adjust the distance between lens and the optical sensor. The image-analyzing module 36 connected to the base 38 is used to analyze an image signal received by the optical sensor on the base 38. The distance-adjusting module 34, connected to the base 38 and the image-analyzing module 36, delivers an analyzed signal to the distance-adjusting module 34 when the image-analyzing module 36 analyzed the image signal and passed it to the distance-adjusting module 34. The distance-adjusting module 34 controls the adjustment device 35 to adjust the distance between the lens and the optical sensor according to the analyzed signal. The stain-detecting module 32 connected to the base 38 is used to determine if the image signal received by the optical sensor is disturbed by stains. The packaging module 31 is used to package the lens and the optical sensor to form an optical sensing module.

A portion of the image signal, instead of the whole image signal, is analyzed by a logic device 37 in the image-analyzing module 36. The logic device 37 can determine the clearness of an image signal by an FD (the focus-value measure based on Difference). If the FD of an image is greater, the image is clearer. Suppose a selected portion of an image signal consists of a plurality of pixels. The pixels located in Gb (or Gr) of the Color Filter are expressed as g(x,y). The gradient in the x-axis is Gx and the gradient in the y-axis is Gy. Gx, Gy, and the FD are expressed as follows:

$$Gx = g ( x , y ) - g ( x + 1 , y )$$

$$Gy = g ( x , y ) - g ( x , y + 1 )$$

$$FD = {\sum }_{x} {\sum }_{y} \{ {G}_{x}^{2} + {G}_{y}^{2} \}$$

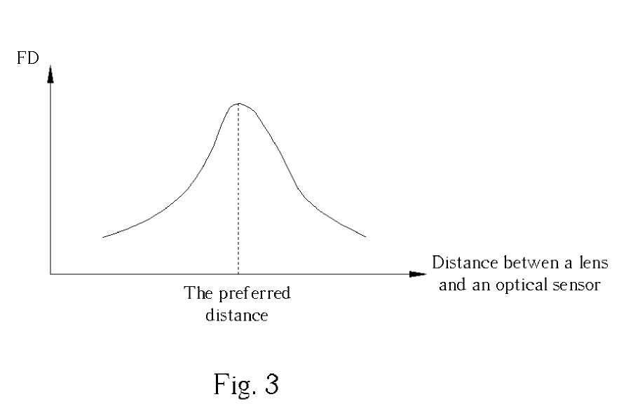

When the distance between the lens and the optical sensor is different, the FD of the received image signal by the image-analyzing module 36 are different. Please refer to FIG. 3. FIG. 3 illustrates the FD (The focus-value measure based on Difference) under different distances between the lens and the optical sensor. The x-axis of the figure represents the distance between the lens and the optical sensor, and the y-axis represents the FD. As shown in FIG. 3, when the distance between the lens and the optical sensor is the preferred distance, the FD is greatest. The automatic-packaging apparatus 30 packages the optical sensing module with the preferred distance.

Operation of each module in the automatic-packaging apparatus 30 is as follows: The distance-adjusting module 34 controls adjustment of the distance between the lens and the optical sensor in the base 38. When the distance is being adjusted, the image-analyzing module 36 analyzes the FD under different distances. If the FD becomes small enough during adjustment of distance, the distance-adjusting module 34 controls the adjustment device 35 in the base 38 to inversely adjust the distance between the lens and the optical sensor (shorten the increasing distance and lengthen the decreasing distance). On the other hand, if the FD becomes larger during adjustment of the distance, the distance is adjusted in the same way until the FD decreases. According to the FIG. 3, the preferred distance occurs at the transition of the curve. Therefore, the distance-adjusting module 34 and the image-analyzing module 36 cooperate with each other to locate the preferred distance. Then the packaging module 31 packages the optical sensing module with the preferred distance.

When the distance-adjusting module 34 performs adjustment of distance, the distance between the lens and the optical sensor is adjusted in different step sizes. In the beginning, the distance-adjusting module 34 adjusts the distance in a larger step. When the adjusting procedure undergoes the transition of the FD curve according to the FIG. 3, the distance is adjusted inversely in a smaller step. The above procedures are repeated until the preferred distance is found. The adjustment in different step sizes makes the adjustment job fast and accurate.

The automatic-packaging apparatus 30 of the present invention further comprises the stain-detecting module 32 to detect stains or broken spots on the lens or on the optical sensor. The stain-detecting module 32 comprises a memory 33 for storing a predetermined standard image. The predetermined standard image is a reference image representing the standard image of a light source. Suppose that the lens and the optical sensor to be packaged are of good quality, the image of the light source transmitted to the stain-detecting module 32 through the lens and the optical sensor should be the same as the predetermined standard image stored in the memory 33. Otherwise, if the received image of the stain-detecting module 32 is different from the predetermined standard image in the memory 33, it would mean that the lens or the optical sensor are maculate.

The image signal received by the optical sensor and passed to the stain-detecting module 32 is divided into a plurality of sub-image signals. Each sub-image signal represents a pixel on the optical sensor and corresponds to a location. On the other hand, the predetermined standard image is also divided into a plurality of standard sub-images, which also corresponds to a location of the optical sensor. When the stain-detecting module 32 compares the received image signal with the predetermined standard image signal, those sub-images of the received image and the predetermined standard image corresponding to the same location are compared. Therefore, the stains or the broken spots of the optical sensor and the lens can be located.

In addition, the function of the stain-detecting module can be implemented by the image-analyzing module. Therefore, in the second embodiment of the present invention, the automatic-packaging apparatus comprises a distance-adjusting module 34, an image-analyzing module 36, a packaging module 31 and a base 38. The distance-adjusting module 34, the packaging module 31 and the base 38 are the same as what is mentioned previously. The image-analyzing module 36 includes the function of stain-detecting in addition to the original function.

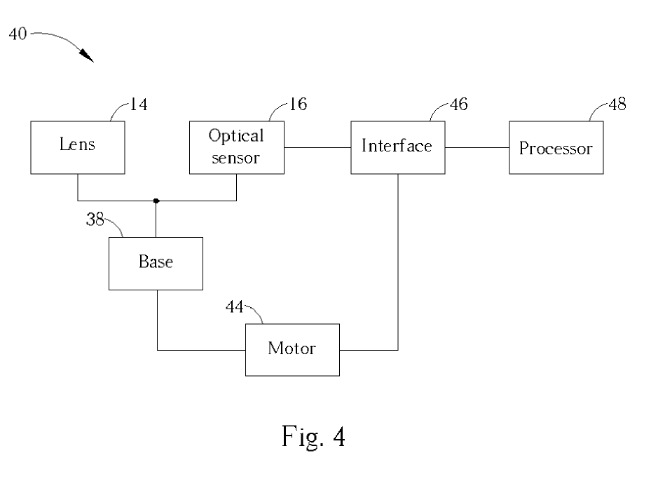

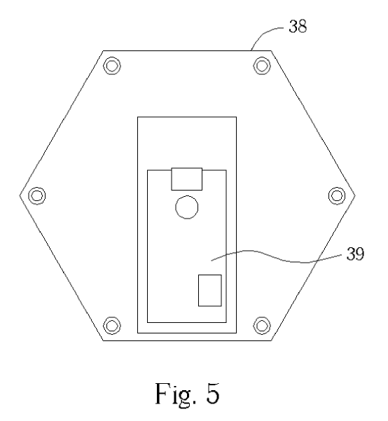

Please refer to FIG. 4. FIG. 4 illustrates another embodiment of the automatic-packaging apparatus 40 according to the present invention. The automatic-packaging apparatus 40 comprises lens 14, an optical sensor 16, a base 38, a motor 44, an interface 46, and a processor 48. The base 38 is used for supporting the lens 14 and the optical sensor 16, between which there is an adjustable distance. An image signal received by the optical sensor 16 is transmitted to the interface 46. The interface 46 passes the image signal to the processor 48. The processor 48 is used to analyze the image signal and delivers the analyzed result to the interface 46. The motor 44 is used to adjust the distance between the lens 14 and the optical sensor 16. The interface 46 controls the motor 44 according to the analyzed result of the processor 48 to make the lens 14 move apart from the optical sensor 16 and reach a preferred distance. Please refer to FIG. 5. FIG. 5 illustrates the structure of the base 38 according to the present invention. The base 38 comprising a cover 39 for fixing or protecting the lens 14 and the optical sensor 16 makes the procedure of packaging easier.

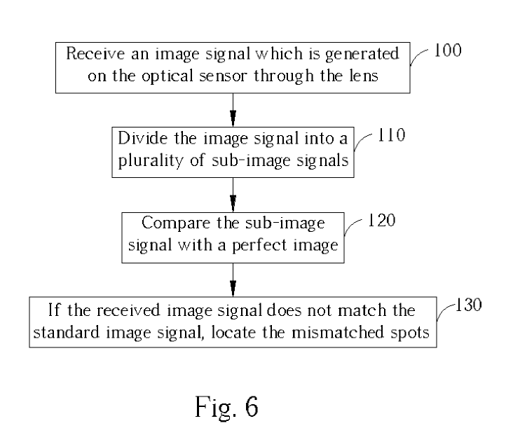

Please refer to FIG. 6. FIG. 6 illustrates a method of detecting a lens or an optical sensor according to the present invention. In step 100, receive an image signal which is generated on the optical sensor through the lens. In step 110, divide the image signal into a plurality of sub-image signals, which correspond to different locations on the optical sensor. In step 120, compare the sub-image signal with a predetermined standard image which is a reference image signal for comparison. In step 130, if the received image signal does not match the predetermined standard image signal, locate the mismatched spots which may be the stains or the broken points on the optical sensor or the lens.

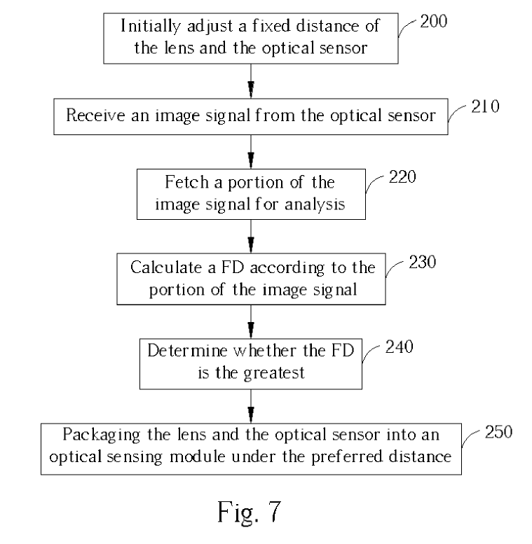

Please refer to FIG. 7. FIG. 7 illustrates the flowchart of deciding the preferred distance between a lens and an optical sensor in an optical sensing module according to the present invention. In step 200, initially adjust a fixed distance of the lens and the optical sensor. In step 210, receive an image signal from the optical sensor. In step 220, fetch a portion of the image signal for analysis. In step 230, calculate an FD according to the portion of the image signal. As mentioned above, an FD is used to determine the clearness of an image. An image with larger FD is considered to be clearer. In step 230, the calculation of FD undergoes the following steps:
(a) In the portion of the image signal, a horizontal deviation is shown as Gx=g(x,y)−g(x+1,y), wherein (x,y) represents the location corresponding to Gb (or Gr) in the Color Filter. Obtain Gx²;
(b) In the portion of the image signal, a vertical deviation is shown as Gy=g(x,y)−g(x,y+1), wherein (x,y) represents the location corresponding to Gb (or Gr) in the Color Filter. Obtain Gy²;
(c) Obtain Gx²+Gy² and then generate an FD.

In step 240, determine whether the FD obtained from step 230 becomes smaller and is small enough. If it is so, then change the adjusting steps as well as the adjusting trend, or repeat step 210, step 220 and step 230. When the greatest FD is obtained, stop changing the distance between the lens and the optical sensor. In step 250, the lens and the optical sensor are packaged into an optical sensing module with the preferred distance.

In the present invention, an image-analyzing module and a distance-adjusting module are utilized to adjust the distance between the lens and the optical sensor to the preferred distance so that the packaged optical sensing module can detect a clear image on the optical sensor. In addition, the automatic-packaging apparatus of the present invention has a stain-detecting module for detecting and further locating stains or broken points of lens or an optical sensor of an optical sensing module. The present invention combines the procedures of packaging and optical detecting using automatic devices for shortening the time of packaging and testing, reducing labor work, and improving production efficiency as well as detecting accuracy.

In the prior art, packaging an optical sensing module has the disadvantages that determining clearness is not definite and consistent, focusing is not economic and efficient, and detecting stains on lens or some broken points on an optical sensor is difficult. The automatic-packaging apparatus which can automatically package an optical sensing module with a preferred distance between a lens and an optical sensor according to the present invention comprising an image-analyzing module, a distance-adjusting module and a stain-detecting module has an advantages of high efficiency, low cost, and short processing time.

Those skilled in the art will readily observe that numerous modifications and alterations of the device may be made while retaining the teachings of the invention. Accordingly, the above disclosure should be construed as limited only by the metes and bounds of the appended claims.

1. An automatic-packaging apparatus for packaging an optical sensing module including a lens and an optical sensor, comprising:
a base for supporting the lens and the optical sensor, comprising an adjustment device for adjusting the distance between the lens and the optical sensor;
an image-analyzing module for analyzing an image signal received from the optical sensor and outputting an analyzed result;
a distance-adjusting module, coupled to the base and the image-analyzing module, for controlling the adjustment device to adjust the distance between the lens and the optical sensor according to the analyzed result; and
a packaging module for packaging the lens and the optical sensor into an integral part.

2. The automatic-packaging apparatus in claim 1 wherein the distance-adjusting module comprises a motor.

3. The automatic-packaging apparatus in claim 1 wherein the image-analyzing module is used to determine whether there are stains or broken points on the lens or on the optical sensor according to the image signal.

4. The automatic-packaging apparatus in claim 1 further comprising a stain-detecting module which is coupled to the base for determining whether there are stains or broken points on any one of the lens and on the optical sensor according to the image signal and a predetermined standard image.

5. The automatic-packaging apparatus in claim 4, wherein the stain-detecting module comprises a memory to store the predetermined standard image.

6. The automatic-packaging apparatus in claim 1 further comprising a memory built in the image-analyzing module for storing the image signal.

7. A method of packaging an optical sensing module including a lens and an optical sensor, comprising:
(a) receiving an image signal from the optical sensor;
(b) extracting a portion of the image signal;
(c) calculating an FD of the portion of the image signal;
(d) adjusting the distance between the lens and the optical sensor according to the FD; and
(e) packaging the lens and optical sensor into an integral part.

8. The method of claim 7 wherein calculating an FD comprises the following steps:
(c1) in the portion of the image signal, obtaining a square of a horizontal deviation Gx², wherein Gx=g(x,y)−g(x+1,y);
(c2) in the portion of the image signal, obtaining a square of a vertical deviation Gy², wherein Gy=g(x,y)−g(x,y+1); and
(c3) calculating Gx²+Gy² and then obtaining the FD.

9. The method of claim 7 wherein in step (d) adjusting the distance between the lens and the optical sensor involves adjusting the distance in a convergent way.

10. The method of claim 7 wherein in step (d) adjusting the distance between the lens and the optical sensor desires to determine the distance rendering the maximum value of FD.
